(19) United States
(12) Patent Application Publication
(10) Pub. No.: US 2023/0147672 A1
(43) Pub. Date: May 11, 2023

(54) HEAT TREATMENT METHOD FOR STEEL PRODUCT, STEEL PRODUCT AND BEARING RING

(71) Applicants: Aktiebolaget SKF, Göteborg (SE); SKF (China) Co Ltd, Shanghai (CN)

(72) Inventors: Feizhou Zhang, Shanghai (CN); Meng Zhang, Shanghai (CN); Ming Li, Shanghai City (CN); Yunfeng Song, Suzhou (CN); Ping Huang, Shanghai City (CN); Karl Åke Staffan Larsson, Göteborg (SE)

(21) Appl. No.: 17/962,476

(22) Filed: Oct. 8, 2022

(30) Foreign Application Priority Data
Nov. 8, 2021 (CN) 202111312824.9

(51) Int. Cl. C21D 6/00; C22C 38/18; C22C 38/02; C21D 9/40

(52) U.S. Cl. CPC C21D 6/008; C22C 38/18; C22C 38/02; C21D 6/005; C21D 6/002; C21D 9/40; C21D 2211/001

(57) ABSTRACT

The invention provides a heat treatment method for a steel product. The steel product includes at least 0.5-0.7% of Si by weight; the method provides the following steps: step 1) putting the steel product under an Austenitizing temperature of 830-890° C. and lasting for a first time to Austenitize the steel product, step 2) immersing the Austenitized steel product in a salt bath at an isothermal temperature of 200-350° C. and lasting for the second time. The method of the invention improves the toughness and elongation of the steel product, keeps the wear resistance of the product, and can be well applied to the fields of thin section ring of bearings and the like. The invention also provides a steel product and a bearing ring.

### CROSS-REFERENCE TO RELATED APPLICATIONS

This application claims priority to Chinese Patent Application no. 202111312824.9, filed Nov. 8, 2021, the contents of which is fully incorporated herein by reference.

### TECHNICAL FIELD

The invention relates to a heat treatment method for a steel product, in particular to a heat treatment method adopting Bainite quenching process. The invention also relates to a steel product and a bearing ring.

### TECHNICAL BACKGROUND

In the field of steel, heat treatment thereof is a common means to optimize the properties of steel. For example, in this field, there is a heat treatment method called Bainite quenching process, which usually adopts heating and Austenitizing a steel or a steel component, then rapidly cooling to a Bainite transformation temperature range and holding it isothermally, so as to be transformed into Bainite and improve the hardness of the material, thus realizing high loading capacity and wear resistance of the material.

Although Bainite quenching process can be applied to some steels, for some steels with better surface fatigue resistance and elastic limits, such as some steels used for bearings, the effect of Bainite quenching process is often not ideal due to the compositions and properties of said steels, and sometimes it is even difficult to adopt Bainite quenching process as a heat treatment means. Particularly for the steels and the steel members with a certain content of carbon (C), chromium (Cr), silicon (Si) and manganese (Mn), it is often impossible to adopt Bainite quenching process.

In the field of bearings, common bearing steels have good wear resistance, but the mechanical properties thereof such as toughness are poor, and its fatigue life span is relatively limited. However, for an ordinary ductile steel, despite its good toughness and elongation, it has poor wear resistance, so it is difficult to be used for bearing and other related fields. Due to the requirements of hardness and load, bearing steels, such as those used in some small deep groove ball bearings and thin section ball bearings (TSBB) for harmonic drive applications, are often quenched by Martensite quenching process instead of Bainite quenching process, which has high hardness but is relatively brittle, and is suitable for bearing working conditions under Hertz contact pressure. However, bearing steels after Martensite quenching may be sacrificed in toughness and ductility. Therefore, if this kind of steels can be subjected to Bainite heat treatment, it can not only improve the toughness of the steel, but also maintain high surface fatigue resistance. In other words, if there is a proper amount of Bainite structure in bearing steels, the related properties can be improved in all aspects, and it can be the best solution for high toughness fully-hardened steels.

For example, for thin section rings operating under structural load, conventional heat treatment may not be the best treatment method. In order to improve the toughness of the materials, steel with Bainite structure (such as GCr15SiMn, etc.) can be used in these applications.

Compared with the steels usually used for thin section rings, this kind of steels (such as GCr15SiMn, etc.) usually has better mechanical properties (including elasticity), due to the addition of alloy elements similar to spring steel, such as Si, Mn, etc. However, in practice, it is difficult to apply the conventional heat treatment method (particularly the conventional Bainite heat treatment method) to this kind of steels. Specifically, a higher Si content in this kind of steels will prolong the Bainite transformation time. Moreover, in order to obtain qualified Bainite structure, a conventional method is to heat the material under a higher Austenitizing temperature and prolong the isothermal transformation time in a salt bath. Compared with ordinary heat treatment method, it takes longer time to adopt this heat treatment method, which will greatly increase the production cost.

Therefore, the field expects to improve the Bainite quenching process of the prior art, so that it can be more widely used, so that such treated steel can maintain high toughness, and at the same time, obtain higher wear resistance, and improve its comprehensive property.

### SUMMARY OF THE INVENTION

In order to solve the above technical problems, this application proposes to implement Bainite quenching process for a steel product with a certain content of carbon, chromium, silicon and manganese.

Therefore, the invention provides a heat treatment method for a steel product, wherein the steel product comprises at least 0.5-0.7% of Si by weight; the method comprises the following steps: step 1) putting the steel product under an Austenitizing temperature of 830-890° C. and lasting for a first time to Austenitize the steel product, step 2) immersing the Austenitized steel product in a salt bath at an isothermal temperature of 200-350° C. and lasting for the second time.

The invention also provides a steel product obtained by the heat treatment method, wherein the residual Austenite content of the steel product is less than 3%, and the Bainite hardness of the steel product is 58-62HRC.

The invention also provides a bearing ring, being made of a steel obtained by the heat treatment method for a steel product of the invention, or being a bearing ring heat-treated by the heat treatment method for a steel product of the invention.

Compared with the prior art, the technical solution of the invention can realize many advantages, including but not limited to:

overcoming the technical prejudice and technical difficulties in the prior art that it is difficult or impossible to adopt Bainite quenching to treat certain steel product (particularly the steel product with a certain content of carbon, chromium, silicon and manganese as mentioned above, such as bearing steel GCr15SiMn, 100CrMnSi6-4, etc.), so that the steel product treated by the above heat treatment method not only has higher toughness and elongation, but also has good wear resistance, which makes the steel product after such heat treatment (particularly the bearing steel) is particularly suitable for applications with structural fatigue requirement in polluted environment.

### BRIEF DESCRIPTION OF THE DRAWINGS

At least one of the embodiments of the present invention is accurately represented by this application's drawings which are relied on to illustrate such embodiment(s) to scale and the drawings are relied on to illustrate the relative size, proportions, and positioning of the individual components of the present invention accurately relative to each other and relative to the overall embodiment(s). Those of ordinary skill in the art will appreciate from this disclosure that the present invention is not limited to the scaled drawings and that the illustrated proportions, scale, and relative positioning can be varied without departing from the scope of the present invention as set forth in the broadest descriptions set forth in any portion of the originally filed specification and/or drawings. FIG. 1 shows a heat treatment process according to a preferred embodiment of the present invention.

FIG. 2 shows a heat treatment process according to another preferred embodiment of the present invention.

FIG. 3 is a schematic diagram showing a bearing ring.

### DETAILED DESCRIPTION OF THE INVENTION

Those of ordinary skill in the art will appreciate from this disclosure that when a range is provided such as (for example) an angle/distance/number/weight/volume/spacing being between one (1 of the appropriate unit) and ten (10 of the appropriate units) that specific support is provided by the specification to identify any number within the range as being disclosed for use with a preferred embodiment. For example, the recitation of a percentage of copper between one percent (1%) and twenty percent (20%) provides specific support for a preferred embodiment having two point three percent (2.3%) copper even if not separately listed herein and thus provides support for claiming a preferred embodiment having two point three percent (2.3%) copper. By way of an additional example, a recitation in the claims and/or in portions of an element moving along an arcuate path by at least twenty (20°) degrees, provides specific literal support for any angle greater than twenty (20°) degrees, such as twenty-three (23°) degrees, thirty (30°) degrees, thirty-three-point five (33.5°) degrees, forty-five (45°) degrees, fifty-two (52°) degrees, or the like and thus provides support for claiming a preferred embodiment with the element moving along the arcuate path thirty-three-point five (33.5°) degrees. A heat treatment method for a steel product according to the present invention is further described below with reference to the accompanying drawings. It should be understood that the method of the present invention is described as a heat treatment method for a steel product, which is not only suitable for heat treatment of steels before manufacturing the same into steel members, but also suitable for steel members being manufactured (such as bearing rings), so the concept of steel product covers steels and steel members.

The invention provides a heat treatment method for a steel product, which is particularly suitable for a steel product at least having high Si content. Specifically, the steel product contains at least 0.5-0.7% of Si by weight. Further, preferably, the steel product comprises at least 1.00-1.20% of Mn by weight. Further, preferably, the steel product comprises at least 0.92-1.05% of C and 1.40-1.65% of Cr by weight.

It is found after research that this kind of steels contain high content of Si and even alloy elements such as Mn, and it takes a long transformation time to obtain qualified Bainite structure, so the choice of Austenitizing temperature and time has great influence thereon. At the same time, these parameters such as Austenitizing temperature and time will also affect the properties of the final product. In order to reduce the transformation time and grain size, the present invention further designs and optimizes the Austenitizing process, by preferably adopting a lower Austenitizing temperature. The reason is that less alloy content will dissolve into Austenite, and the influence of Si will be minimized (for example, the content of Si is about 0.6%), otherwise, the stability of Austenite transformation will be decreased. Therefore, the method of the invention reduces the time of isothermal transformation. However, the temperature still needs to reach a certain level to meet the hardness requirements of the final product.

Moreover, after Austenitizing, it is necessary to performing quenching in a salt bath to obtain qualified Bainite structure. Generally, the isothermal transformation of the above steels takes a longer time than that of ordinary steels. In order to speed up the isothermal transformation process and make the final product have better toughness, a higher salt bath temperature can be selected. Higher isothermal temperature will lead to shorter transformation time and more coarse microstructure, and at the same time, relatively lower hardness can be obtained, which is suitable for specific application scenarios that require certain toughness.

Specifically, referring to FIG. 1, the heat treatment method of the present invention includes the following steps:

step 1), putting a steel product under an Austenitizing temperature of 830-890° C. and lasting for a first time to Austenitize the steel product,

step 2), immersing the Austenitized steel product in a salt bath at an isothermal temperature of 200-350° C. and lasting for a second time.

Preferably, the heat treatment method for a steel product according to the present invention is suitable for bearing steels with grades of GCr15SiMn, 100CrMnSi6-4, etc. In particular, this method is suitable for steel with the following chemical compositions: 0.92-1.05% of C, 0.5-0.7% of Si, 1.00-1.20% of Mn, 1.40-1.65% of Cr, 0-0.02% of P, 0-0.015% of S, 0-0.25% of Ni, 0-0.10% of Mo, 0-0.30% of Cu, with the rest of Fe.

Preferably, the above Austenitizing temperature, the first time, the salt bath temperature and/or the second time can be further adjusted and optimized.

For example, the Austenitizing temperature may be 840° C.-880° C., and the first time may be 15-45 minutes. For example, the temperature of the salt bath may be 210-290, and the second time may be 4-11 hours. Therefore, various combinations of heat treatment temperature and time can be selected according to different steel grades, property requirements and treatment cost requirements.

According to a particularly preferred embodiment of the present invention, in step 1), the Austenitizing temperature is 840° C.-880° C. and the first time is 30 minutes; in step 2), the temperature of the salt bath is 250° C., and the second time is 6-9 hours.

When the method of this preferred embodiment is applied to bearing steels with the grades of GCr15SiMn, 100CrMnSi6-4, etc., the Bainite in the steel product after heat treatment can be better optimized, and its Bainite hardness can reach 58-62 HRC, while the residual Austenite content can be less than 3%. Therefore, the bearing steel after such heat treatment will be particularly suitable for the manufacture of thin section rings for bearings. Or, the above heat treatment method can be applied to the bearing rings made of such bearing steel, and the same effect can be obtained. For those applications that have no special requirements for dimensional stability, the content of residual Austenite can be further increased to improve the toughness of materials. This also means that in the heat treatment of materials used in these applications, the time of salt bath can be further reduced to provide its required mechanical properties.

According to another preferred embodiment of the present invention, further optimization adjustment can be made for the isothermal immersing in the salt bath in step 2). As Bainite transformation requires a certain cooling rate, after the Austenitized steel product is cooled to the required temperature in the salt bath, the product can be put into an air tempering furnace for later transformation. A preferred operation is, for example, after the Austenitized steel product is quenched and stabilized in the salt bath for a certain time, the temperature of the core and surface of the steel product will be generally the same as that of the salt bath, and then the steel product can be transferred to an air tempering furnace for further treatment. At this time, the salt bath can be used for quenching and transformation of another steel product to improve the overall productivity.

For example, after immersing in a salt bath at an isothermal temperature for the second time, the steel product can be isothermally tempered in an air tempering furnace at 200-280° C. (for example, about 250° C.) for the third time, thereby reducing the cost and improving the feasibility of mass production.

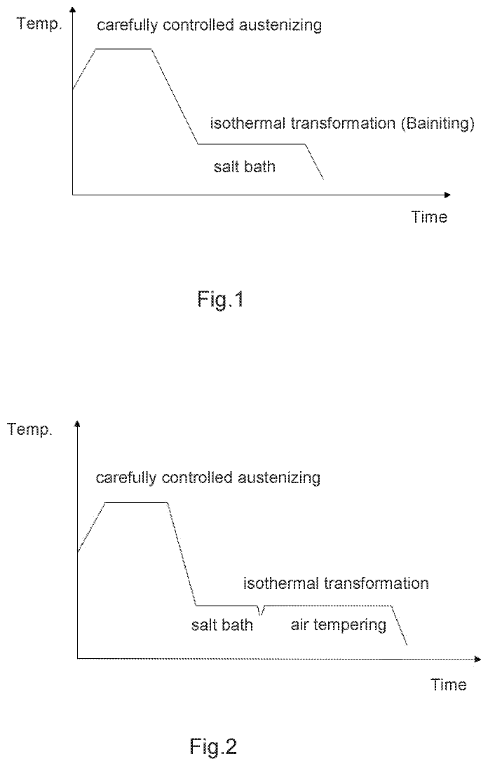

In another preferred embodiment according to FIG. 2, compared with the previous embodiment, the second time for the salt bath immersing can be shortened, for example, shortened to 3-7 hours, while the third time for the isothermal tempering in the air tempering furnace can be set to, for example, 2-3 hours, and the temperature of isothermal tempering in the air tempering furnace is, for example, 250° C. . Therefore, the immersing time for salt bath is shortened by introducing the heat treatment stage of isothermal tempering in air tempering furnace, which not only improves the heat treatment efficiency, but also reduces the cost.

To sum up, the treatment method for a steel product of the present invention can be applied to a steel product that is traditionally difficult to be applied with Bainite quenching, so that the toughness and wear resistance of the steel product after heat treatment can be optimized and balanced.

After heat treatment according to the method of the invention, the steel product can be improved with a comprehensive property, including good toughness, fatigue strength, ductility, wear resistance and the like. By increasing the toughness and ductility of the steel product, the fatigue strength of the steel product can be improved, so that the steel product can be used in applications requiring high structural loads. In addition, the wear resistance can be improved through the selection of materials and processes.

Particularly, after the bearing steel (such as GCr15SiMn, 100CrMnSi6-4, etc.) is subjected to the heat treatment according to the present invention, the treated bearing steel is particularly suitable for manufacturing thin section rings for bearings, particularly for small deep groove ball bearings (DGBB) and thin section ball bearing (TSBB) for harmonic drive applications. In particular, for example, in applications in polluted environment, the wear resistance can be effectively improved by imposing the bearing steel with the required Bainite microstructure. In addition, according to the heat treatment method of the present invention, since the elongation and toughness of the bearing steel are also improved, the braking of the bearing ring during application can be prevented.

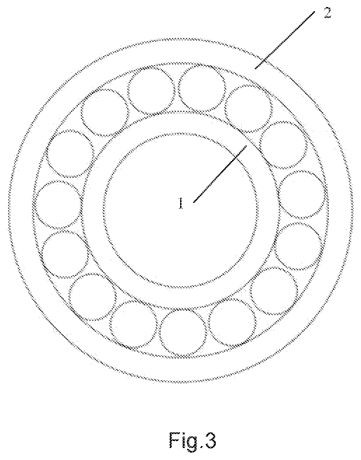

Bearing rings generally include an inner ring and an outer ring. Therefore, for example, the heat treatment method of the present invention can be implemented for the inner ring and/or the outer ring of the bearing. Specifically, referring to FIG. 3, the inner ring 1 and/or the outer ring 2 of a bearing can be a steel bearing ring heat-treated by the heat treatment method for a steel product of the present invention, or can be made of a steel obtained by the heat treatment method of the steel product of the present invention.

The exemplary implementation of the scheme proposed in this disclosure has been described in detail above with reference to the preferred embodiments. However, it can be understood by those skilled in the art that without departing from the concept of this disclosure, various changes and modifications can be made to the above specific embodiments, and various technical features and structures proposed in this disclosure can be combined in various ways without exceeding the scope of protection of this disclosure, which is determined by the appended claims.

1. A heat treatment method for a steel product comprising:
providing the steel product comprises at least 0.5-0.7% of Si by weight;
putting the steel product under an Austenitizing temperature of 830-890° C. and lasting for a first time to Austenitize the steel product, and
immersing the Austenitized steel product in a salt bath at an isothermal temperature of 200-350° C. and lasting for the second time.

2. The heat treatment method for a steel product according to claim 1, wherein the Austenitizing temperature is 840° C.-880° C. and the first time is 15-45 minutes.

3. The heat treatment method for a steel product according to claim 1, wherein the temperature of the salt bath is 210-290° C. and the second time is 4-11 hours.

4. The heat treatment method for a steel product according to claim 1, wherein the Austenitizing temperature is 840-880° C., and the first time is 30 minutes, and wherein the temperature of the salt bath is 250° C., and the second time is 6-9 hours.

5. The heat treatment method for a steel product according to claim 1, further comprises isothermally tempering the steel product in an air tempering furnace at 200-280° C. for a third time after immersing in a salt bath at the isothermal temperature for the second time.

6. The heat treatment method for a steel product according to claim 5, wherein, the second time is 3-7 hours; and/or the third time is 2-3 hours, and the isothermally tempering temperature in the air tempering furnace is 250° C.

7. The heat treatment method for a steel product according to claim 1, wherein the steel product further comprises at least 1.00-1.20% of Mn by weight.

8. The heat treatment method for a steel product according to claim 1, wherein the steel product is bearing steel with the following chemical compositions by weight: 0.92-1.05% of C, 0.5-0.7% of Si, 1.00-1.20% of Mn, 1.40-1.65% of Cr, 0-0.02% of P, 0-0.015% of S, 0-0.25% of Ni, 0-0.10% of Mo, 0-0.30% of Cu, with the rest of Fe.

9. A steel product obtained by providing a steel product that comprises at least 0.5-0.7% of Si by weight; putting the steel product under an Austenitizing temperature of 830-890° C. and lasting for a first time to Austenitize the steel product, and immersing the Austenitized steel product in a salt bath at an isothermal temperature of 200-350° C. and lasting for the second time, wherein the residual Austenite content of the steel product is less than 3%, and the Bainite hardness of the steel product is 58-62HRC.

10. A bearing ring, being made of a steel obtained by providing a steel product that comprises at least 0.5-0.7% of Si by weight; the steel product subjected under an Austenitizing temperature of 830-890° C. and lasting for a first time to Austenitize the steel product, and the Austenitized steel product bring immersed in a salt bath at an isothermal temperature of 200-350° C. and lasting for the second time, wherein the residual Austenite content of the steel product is less than 3%, and the Bainite hardness of the steel product is 58-62HRC.
